(19) United States
(12) Patent Application Publication
(10) Pub. No.: US 2005/0038709 A1
(43) Pub. Date: Feb. 17, 2005

(54) Marketing apparatus and method

(76) Inventor: Kathleen M. Walton, West Chester, PA (US)

Correspondence Address: Robert S. Lipton, Esqurie;LIPTON, WEINBERGER & HUSICK, 201 North Jackson Street, P.O. Box 934, Media, PA, 19063-0934, US

(21) Appl. No.: 10/637,112

(22) Filed: Aug. 11, 2003

(51) Int. Cl. G06F 17/60

(52) U.S. Cl. 705/26

(57) ABSTRACT

The Invention is an apparatus and method for marketing heartbreak products using a computer network such as the Internet. Suites of products that may provide comfort and support for a grieving person are organized into pre-selected categories. The categories may be specific to the age and gender of the grieving person and to the loss causing the person's grief. A user may access the categories of products using a client computer over the computer network. The client computer communicates with a server computer, which allows the user to select the appropriate category and suite of products.

### BACKGROUND OF THE INVENTION

1. Field of the Invention

The Invention is an apparatus and method for marketing heartbreak products.

2. Description of the Related Art

At its most abstract and clinical, grief is a complex suite of physiological and emotional responses resulting from a change in a familiar pattern or behavior. Grief is inevitable and universal. In one way or another, we all will suffer from grief. As used in this application, the term ‘heartbreak’ means the emotional and physiological response of grief of whatever kind and of whatever cause.

Grief is characterized by loss. A person may grieve the passing of a human life. A person may experience the same emotional turmoil over the death of a personal relationship, the loss of a job, the loss of an item of property, the temporary absence of a loved one or the loss of a pet. A person may grieve the loss of a physical or of a mental ability or a loss during a competition. A person may grieve the changes brought about by surgery or other medical condition.

A grieving person may experience multiple conflicting or compounding emotions vying for the person's attention at the same time. The emotions of grief may be intense, disorganizing and long lasting. The distinction between the emotional upheaval caused by grief and a similar emotional upheaval caused by mental illness may be vanishingly small. Conversely, the degree of emotional upheaval caused by grief may vary enormously from one person to the next and among situations. No one would deny the grief experienced by a parent at the loss of a child. The grief experienced by a twelve-year old at being excluded by her peers is no less real and may be no less intense.

Expressions of empathy and sympathy from others may be of benefit to the grieving person. While no expression by a bystander can cause the grieving person to stop feeling the emotional turmoil of grief, expressions of support and sympathy may allow the grieving person to experience hope beyond the grief and may help to avoid a residue of depression left in the wake of the grief.

### SUMMARY OF THE INVENTION

The Invention is an apparatus and method of marketing products for persons who are grieving, particularly persons who are experiencing the heartbreak of the end of a romantic relationship or experiencing the heartbreak associated with the absence of a loved one. The products may be purchased by persons wishing to make a gesture of support for the heartbroken person or may be purchased by the heartbroken person as a special treat and self-acknowledgement of the pain the person is experiencing. The products comprise a selection of age and gender appropriate products such as comestibles and personal care products, books of personal affirmations and other items that may offer support and comfort for the heartbroken person.

The Invention is organized as a selection of suites of products, categorized by age and gender-appropriate content. The suite of products may be selected to be appropriate to the nature of the particular loss being mourned.

To practice the Invention, a user will utilize a client computer. The user will obtain access to a server computer over a network, such as the Internet. The client computer, and hence the user, will be presented with a menu of suites of products categorized based upon the age, gender and content specific to common grief-inducing situations. The user may select among the menu of suites of products. The user may order the suite of products and have the suite of products delivered to the grieving person.

### BRIEF DESCRIPTION OF THE DRAWINGS

FIG. 1 is a block diagram of the Invention.

FIG. 2 is the first part of a two part flow chart of the Invention.

FIG. 3 is the second of a two part flow chart of the Invention.

FIG. 4 is a block diagram of the menu of the Invention.

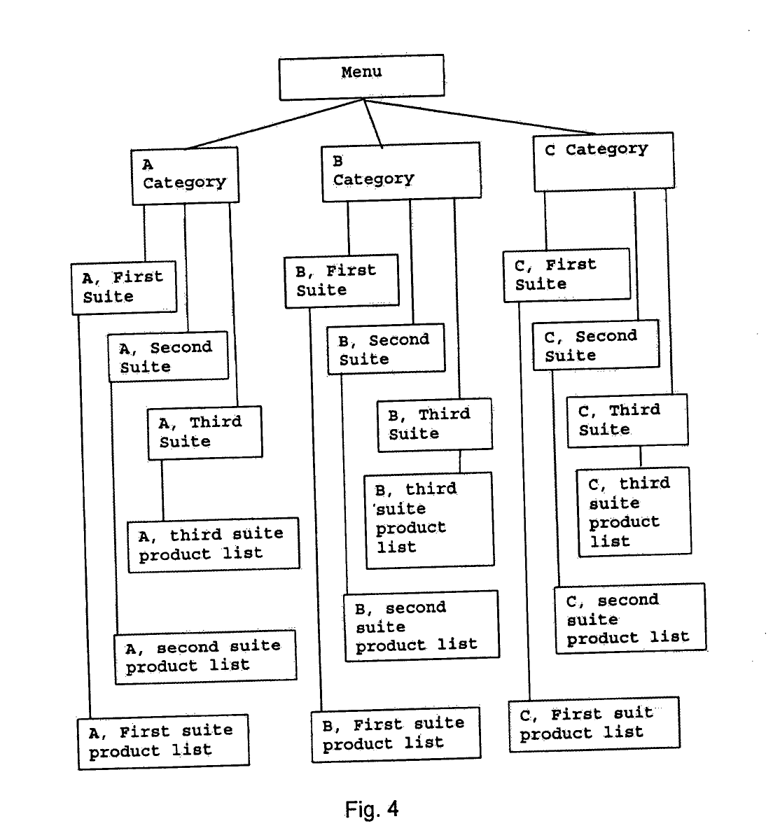

### DETAILED DESCRIPTION OF AN EMBODIMENT

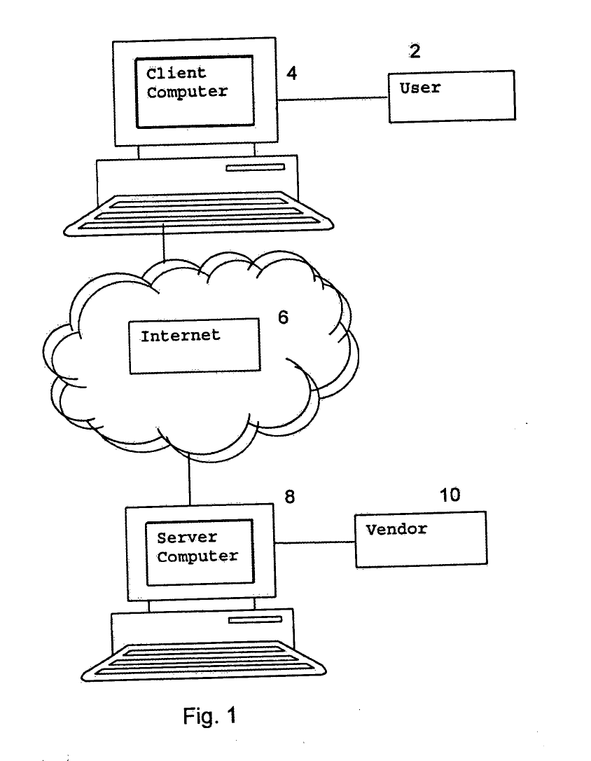

As shown by FIG. 1, a user 2 utilizes a client computer 4 connected to a computer network 6. The computer network 6 may be a local area network 6 or a wide area network 6, such as the Internet. The client computer 4 communicates with a server computer 8 through the network 6. For the purposes of this application, a client computer is any computer capable of connecting to a server computer 8 over a network 6. For purposes of this application, a server computer 8 is any computer capable of connecting to a client computer 4 over a network 6. The server computer 8 is operated under the control of the vendor 10 and communicates with the vendor 1.0.

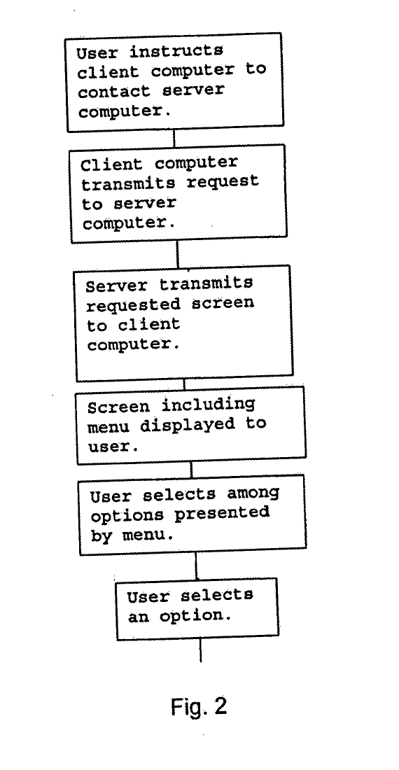

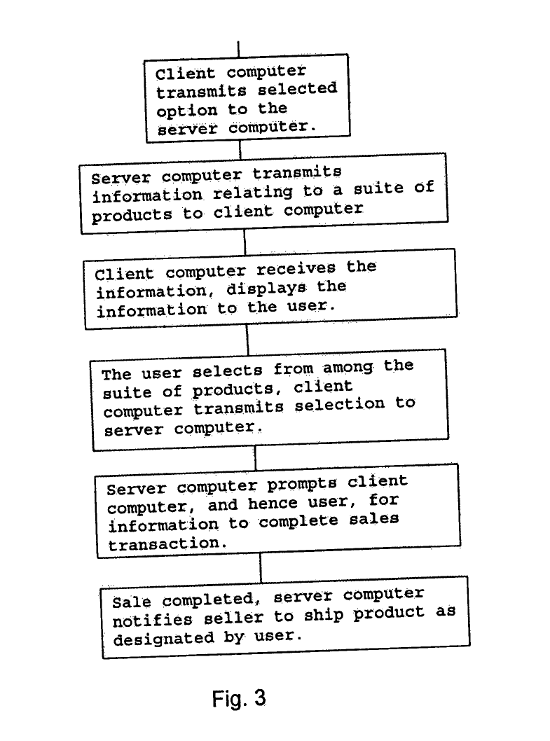

FIGS. 2 and 3 comprise a flow chart consisting of two figures. As shown by FIG. 2, the user 2, who may be the person who is heartbroken or another person who wishes to offer the heartbroken person support, connects a client computer 4 to the network 6. The user 2 directs a query to the server computer 8. In response to the query by the client computer 4, the server computer 8 transmits a menu as shown by FIG. 5 to the client computer 4, which displays the menu to the user 2.

From FIG. 5, the menu comprises several categories from which the user 2 may choose. The categories are selected by the vendor 10 so as to reflect the expected circumstances of the heartbroken person, whether or not the heartbroken person is also the user 2. For example, the categories (designated in FIG. 5 as example categories A, B and C) may discriminate among adult women, college-age women or teenage girls. The categories may reflect gender differences by establishing separate categories for boys or adult men. The Invention contemplates any number of categories.

The categories may reflect the grounds for a loss giving rise to heartbreak. For example, a category may address the heartbreak caused by the end of a romantic relationship. Alternatively, a category may address heartbreak caused by the loss of a pet or the death of a loved one. A category may address heartbreak caused by temporary separation, such as the heartbreak felt by those left behind by a soldier going off to war.

The categories may address adult content themes. The categories also may address the anger that a grieving person also may feel by providing products allowing an outlet for that anger.

The products under each category are organized into separate suites of products by price, with each suite including several products. For example, a category directed to adult women heartbroken by the end of a romantic relationship may include the following suites of products, in decreasing order of price:

First suite of products: a candle, a meditation CD, a chocolate bar cc, bath gel, a bath puff, a pedicure set, a spa kit, a self-help book on ending a relationship and candies. Second suite of products: a candle, a chocolate bar, bath gel, a bath puff, a pedicure set a spa kit and candies. Third suite of products: a candle, a chocolate bar, bath gel, a bath puff, a pedicure set and candies. As can be seen from the above example, the higher-priced suites of products include more products than the lower-priced suites.

The products selected for the suites of the age-specific categories are selected to be appropriate to that age group. For example, a suite of products designed to appeal to a heartbroken 10 to 14 year old girl may include the following: lip gloss key chain, glitter hair, mascara, glitter nail polish, smiley pen, body glitter, glitter compact, a hair barrette, a plush bear, a chocolate bar and candies.

The products chosen for the gender-specific categories are selected appropriate for the gender. For example, for a suite of products intended to be purchased by a male friend seeking to provide support for a male grieving the end of a romantic relationship, the products may include the following: a cigar, a shot glass with adult images, a hangover kit, cologne, a chocolate bar and candies.

The products chosen for the categories of products also may reflect the cause of the heartbreak. For example, categories of products may be selected to aid a family member grieving the temporary absence of a soldier leaving for war. A suite of products in this category may include items such as: a candle, an American flag pin, aromatherapy spray, dream pillow, a relaxation CD, an American flag, a flag-theme plush bear, a chocolate bar and candies.

Once the user 2 selects the category appropriate for the heartbroken person, the user 2 communicates the category to the client computer 4, which in turn communicates the category to the server computer 8. The server computer 8 transmits the selected category of products to the client computer 4, where the products are displayed to the user 2. The user 2 may instruct the client computer 4, and hence the server computer 8, to display to the user the products contained in the selected suite of products.

Upon display of the suite of products, the user 2 may elect to purchase the suite of products. Conversely, the user 2 may elect to view and to purchase some other suite of products or no products at all. To purchase the suite of products, the user 2 provides appropriate instructions to the client computer 4, which then communicates with the server computer 8. The server computer 8 prompts the client computer 4, and hence the user 2, through a series of screens eliciting payment information and information as to where the vendor 10 will deliver the suite of products. Upon receipt and confirmation of the credit card information, the vendor 10 delivers the suite of products as directed by the user 2 and receives payment from the user's 2 credit card service provider, completing the transaction.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A method for marketing a heartbreak product comprising:
a. selecting a suite of the heartbreak products;
b. classifying said suite of the heartbreak products;
c. offering said classified suite of the heartbreak products for sale on an Internet web site;
d. accepting an order for said suite of the heartbreak products;
e. filling said order for said suite of the heartbreak products.

2. The method of claim 1 wherein said step of selecting said suite of the heartbreak products comprises choosing products that may cooperate one with another to offer comfort and support to a heartbroken person.

3. The method of claim 2 wherein said step of classifying said suite of the heartbreak products comprises assigning an age-appropriate, gender specific and situation specific category designation to said suite of the heartbreak products.

4. The method of claim 3 wherein said step of offering said suite of products for sale comprises adapting a server computer to respond to an appropriate request from a client computer, said server computer then displaying said suite of products to a user, said server computer being adapted to accept payment and delivery information from said user.

5. An apparatus for marketing heartbreak products comprising:
a. a client computer;
b. a server computer;
c. a network, said client computer and said server computer being adapted to communicate one with the other over said network;
d. a menu, said server computer being adapted to transmit and said client computer being adapted to receive and to display said menu to a user;
e. a suite of the heartbreak products, said menu being adapted to display said suite of heartbreak products to said user.

6. The apparatus of claim 5, further comprising:
a. said suite of the heartbreak products comprising a plurality of suites of the heartbreak products, said displaying by said menu of said suite of the heartbreak products comprising said menu being adapted to display each of said plurality of suites to said user;
b. said client computer being adapted so that said user may instruct said client computer to instruct said server computer to select one of said plurality of suites of said heartbreak products, said server computer being adapted to elicit payment and delivery information from said user, said server computer further being adapted to instruct a vendor to deliver said suite of products as instructed by said user.

7. The apparatus of claim 6 wherein said menu categorizes said plurality of suites of heartbreak products based upon a gender of a heartbroken person.

8. The apparatus of claim 7 wherein said menu categorizes said plurality of suites of heartbreak products based upon an age of said heartbroken person.

9. The apparatus of claim 8 wherein said menu categorizes said plurality of suites of heartbreak products based on a circumstance giving rise to a heartbreak of said heartbroken person.

10. An apparatus for marketing heartbreak products, the apparatus comprising:
a. a client computer, said client computer being adapted to communicate with a server computer over a network;
b. said client computer being programmed to receive from said server computer and to display to a user a menu;
c. said client computer being adapted to display a suite of the heartbreak products to said user upon selection of said suite by said user from said menu;
d. said client computer being adapted to send to said server computer a selection of said suite of the heartbreak products;
e. said client computer being adapted to receive a prompt from said server computer for a payment information or a delivery information for said suite of heartbreak products;
f. said client computer being adapted to transmit said payment information and said deliver information to said server computer.

11. The apparatus of claim 10, further comprising,
a. said suite of the heartbreak products comprising a plurality of suites of the heartbreak products, said adaptation of said menu to display said suite of heartbreak products comprising said menu being adapted to display each of said plurality of suites of the heartbreak products to said user;
b. means for selection of one of said plurality of said suites of the heartbreak products by said user.

12. The apparatus of claim 11 wherein said means for selection comprises said client computer being adapted to receive from said user an instruction selecting said one of said suites of the heartbreak products and to transmit said instruction to said server computer.

13. An apparatus for marketing heartbreak products, the apparatus comprising:
a. a server computer, said server computer being adapted to communicate with a client computer over a network;
b. said server computer being programmed to send a menu to said client computer for display to a user;
c. said menu being adapted to display a suite of the heartbreak products to said user;
d. said server computer being adapted to receive from said client computer a selection of said suite of the heartbreak products from said client computer;
e. said server computer being adapted to prompt said client computer for a payment information and a delivery information for said suite of heartbreak products;
f. said server computer being adapted to receive said payment information and said deliver information from said client computer and to notify a vendor of said payment information and of said delivery information.

14. The apparatus of claim 13, further comprising,
a. said suite of the heartbreak products comprising a plurality of said suites of the heartbreak products, said adaptation of said menu to display said suite of heartbreak products comprising said menu being adapted to display each of said plurality of suites of the heartbreak products to said user;
b. means for selection of one of said plurality of suites of the heartbreak products by said user.

15. The apparatus of claim 14 wherein said means for selection of said one of said plurality of suites comprises said server computer being adapted to receive from said client computer an instruction selecting said one of said plurality of suites.
